(19) United States
(12) Patent Application Publication
(10) Pub. No.: US 2022/0217925 A1
(43) Pub. Date: Jul. 14, 2022

(54) WORKING MACHINE

(71) Applicant: HONDA MOTOR CO., LTD., Tokyo (JP)

(72) Inventors: Tsukasa SUGINO, Wako-shi (JP); Makoto YAMAMURA, Wako-shi (JP); Takayuki KAWAI, Wako-shi (JP); Masaya HONJI, Wako-shi (JP)

(21) Appl. No.: 17/561,696

(22) Filed: Dec. 23, 2021

(30) Foreign Application Priority Data
Jan. 12, 2021 (JP) 2021-003010

(51) Int. Cl. A01G 20/47; G05D 1/02

(52) U.S. Cl. CPC A01G 20/47; G05D 1/0214; G05D 1/0223; G05D 1/0289; G05D 1/0219

(57) ABSTRACT

The present invention provides an autonomous work machine including an air blowing portion that is provided in a main body portion and ejects air toward a work plane to generate an airflow, a first acquisition portion that acquires scattered object information regarding scattered objects present in a work area, a second acquisition portion that acquires target information regarding a target position for moving the scattered objects, and a control portion that controls the air blowing portion on the basis of the scattered object information acquired by the first acquisition portion and the target information acquired by the second acquisition portion, wherein the control portion controls a direction and an amount of the air ejected by the air blowing portion so that the scattered objects are moved to the target position by the airflow generated by the air blowing portion.

### CROSS-REFERENCE TO RELATED APPLICATION(S)

This application claims priority to and the benefit of Japanese Patent Application No. 2021-003010 filed on Jan. 12, 2021, the entire disclosure of which is incorporated herein by reference.

### BACKGROUND OF THE INVENTION

### Field of the Invention

The present invention relates to a working machine.

### Description of the Related Art

As one of work machines that perform work such as maintenance of roads and parks, a work machine (blower) that moves (collects) fallen leaves scattered on roads and grass clippings in parks is known. Additionally, International Publication No. 2018/182944 proposes a technique of using a drone (unmanned aerial vehicle) in a work machine that performs pest control work.

On the other hand, in recent years, research and development of a technique related to an autonomous work machine having a function of performing work by automatically and autonomously traveling (autonomously traveling) in a work area without requiring operation by a worker have been advanced for various work machines. In such an autonomous work machine, as disclosed in International Publication No. 2018/182944, for example, a technique for further improving work efficiency by using a drone or the like is required.

### SUMMARY OF THE INVENTION

The present invention provides a new technique related to a work machine.

According to one aspect of the present invention, there is provided an autonomous work machine comprising: a main body portion; an air blowing portion that is provided in the main body portion and ejects air toward a work plane to generate an airflow; a first acquisition portion that acquires scattered object information regarding scattered objects present in a work area; a second acquisition portion that acquires target information regarding a target position for moving the scattered objects; and a control portion that controls the air blowing portion on the basis of the scattered object information acquired by the first acquisition portion and the target information acquired by the second acquisition portion, wherein the control portion controls a direction and an amount of the air ejected by the air blowing portion so that the scattered objects are moved to the target position by the airflow generated by the air blowing portion.

Further aspects of the present invention will become apparent from the following description of exemplary embodiments with reference to the attached drawings.

### BRIEF DESCRIPTION OF THE DRAWINGS

FIG. 1 is a schematic view illustrating a configuration of a work machine according to a first embodiment of the present invention.

FIG. 2 is a diagram illustrating an example of a configuration of a control portion of the work machine illustrated in FIG. 1.

FIG. 3 is a diagram schematically illustrating an example of an operation of the work machine illustrated in FIG. 1.

FIG. 4 is a diagram schematically illustrating an example of an operation of the work machine illustrated in FIG. 1.

FIGS. 5A and 5B are diagrams schematically illustrating an example of an operation of the work machine illustrated in FIG. 1.

FIG. 6 is a schematic view illustrating a configuration of a work machine according to a second embodiment of the present invention.

FIG. 7 is a schematic view illustrating a configuration of a work machine according to a third embodiment of the present invention.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

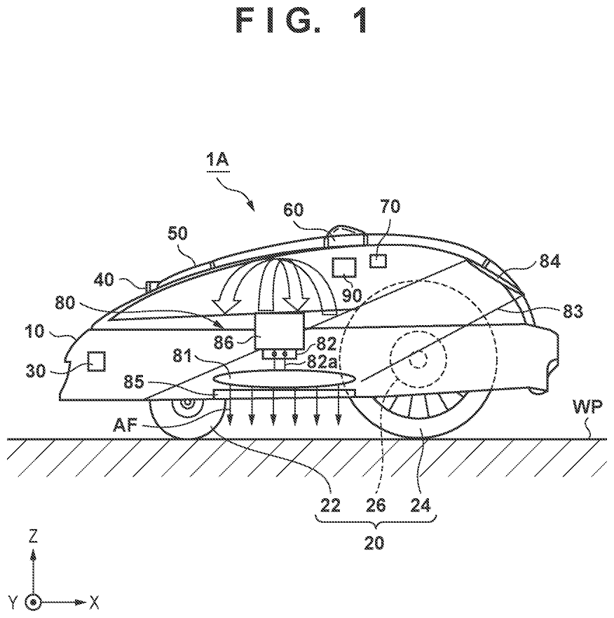

FIG. 1 is a schematic view illustrating a configuration of a work machine 1A according to a first embodiment of the present invention, and is a side view of the work machine 1A. Note that in each drawing including FIG. 1, a coordinate axis X indicates a front-and-rear direction (traveling direction) of the work machine 1A, a coordinate axis Y indicates a width direction of the work machine 1A, and a coordinate axis Z indicates a vertical direction (height direction) of the work machine 1A.

The work machine 1A is an autonomous work machine having a function of performing predetermined work by automatically and autonomously traveling (autonomously traveling) in a work area without requiring operation by a worker, that is, an autonomous working robot. The work machine 1A is embodied as a work machine, a so-called blower, that performs work of moving (collecting) scattered objects present in a work area such as a road or a park as predetermined work. Scattered objects are objects to be moved in the work area or objects to be removed from the work area, and in the present embodiment, fallen leaves, grass clippings, and the like are assumed. Note, however, that scattered objects are not limited thereto, and include snow, for example. As illustrated in FIG. 1, the work machine 1A includes a main body portion 10, a traveling portion 20, a detection portion 30, an area monitoring portion 40, a setting portion 50, an environment monitoring portion 60, a communication portion 70, an air blowing portion 80, and a control portion 90.

The main body portion 10 forms an outer surface of the work machine 1A. The main body portion 10 includes, for example, a frame that is a framework of the work machine 1A and a housing (outer surface) that covers an internal space (accommodation space) defined by the frame.

The traveling portion 20 has a function of causing the work machine 1A to travel, and in the present embodiment, moves the main body portion 10 along a work plane WP of a work area. The traveling portion 20 is provided in the main body portion 10, and includes front wheels 22 disposed on the front left side and the front right side of the work machine 1A and functioning as driven wheels, and rear wheels 24 disposed on the rear left side and the rear right side of the work machine 1A and functioning as drive wheels, as wheels rotatably contacting the work plane WP. Additionally, the traveling portion 20 includes a motor 26 that drives the rear wheels 24 so as to move the main body portion 10 along the work plane WP. In the present embodiment, the work machine 1A (main body portion 10) is supported by four wheels of the front wheels 22 and the rear wheels 24. When the motor 26 drives (rotates) the rear wheels 24, the work machine 1A can be made to travel along the work plane WP. Note, however, that the traveling portion 20 is not an essential requirement for the work machine 1A as described later.

The detection portion 30 is provided in the main body portion 10 and has a function of detecting various types of information regarding traveling of the work machine 1A. The detection portion 30 includes, for example, a current sensor that detects the load of the motor 26 of the traveling portion 20, a GPS sensor that detects the position of the work machine 1A, and a G sensor, a vehicle speed sensor, an angular velocity sensor, and the like that detect the attitude, the vehicle speed, the angular velocity, and the like (state of work machine 1A) of the work machine 1A.

The area monitoring portion 40 is provided in the main body portion 10, and has a function of monitoring the work area of the work machine 1A and acquiring various types of information regarding the work area. The area monitoring portion 40 monitors, for example, whether scattered objects are present in the work area, and if scattered objects are present in the work area, acquires information (scattered object information) regarding the scattered objects. As described above, in the present embodiment, the area monitoring portion 40 functions as a first acquisition portion that acquires scattered object information regarding scattered objects present in the work area. The area monitoring portion 40 acquires, as scattered object information regarding scattered objects, information indicating the position of the scattered objects present in the work area and information indicating the amount of the scattered objects at the position (i.e., position where scattered objects are present). The area monitoring portion 40 includes a detection unit that detects the state of the work area, and specifically includes, as the detection unit, an infrared sensor and a camera that detect scattered objects (e.g., fallen leaves and grass clippings) present in the work area. Additionally, the area monitoring portion 40 can also detect an obstacle (e.g., stone) in the work area.

The setting portion 50 includes a display device such as a liquid crystal display (LCD) or an organic light emitting diode (OLED), and an input device such as a button and an operation key. In the present embodiment, the setting portion 50 is configured as a touch panel provided in the main body portion 10, displays (provides) various graphical user interfaces (GUIs) including a setting screen, a selection screen, and the like, and accepts operations on the GUIs (various settings for work machine 1A). The worker sets a target position to which the scattered objects present in the work area are moved, through (GUI displayed on) the setting portion 50. Additionally, the worker may set, as a destination to move the scattered objects, the target position itself or a direction headed toward the target position (target direction). As described above, in the present embodiment, the setting portion 50 functions as a second acquisition portion that acquires target information (i.e., information indicating target position and information indicating target direction) regarding a target position for moving scattered objects.

The environment monitoring portion 60 is provided in the main body portion 10, and functions as a third acquisition portion that monitors the environment around the work machine 1A (work area) and acquires environment information regarding the environment of the work area. The environment monitoring portion 60 acquires, as environment information regarding the environment of the work area, information indicating the direction of wind (wind direction) in the work area and information indicating the position of a person present in the work area. The environment monitoring portion 60 includes a detection unit that detects the environment of the work area, and specifically includes, as the detection unit, an anemoscope and an anemometer that detect the wind direction and the wind speed in the work area, and an infrared sensor and a camera that detect a person present in the work area. Note that some functions (e.g., function of detecting person) of the environment monitoring portion 60 may be integrated with some functions (e.g., function of detecting scattered objects or obstacle) of the area monitoring portion 40.

The communication portion 70 communicates with an external device such as another work machine through wireless communication such as Bluetooth (registered trademark), and acquires various types of information regarding the other work machine. In the present embodiment, the communication portion 70 communicates with another work machine and acquires route information indicating a route (work route) along which the other work machine moves from the other work machine.

The air blowing portion 80 functions as a work unit that actually performs work of moving scattered objects present in the work area to a target position. The air blowing portion 80 is provided in the main body portion 10, and ejects air toward the work plane WP to generate an airflow AF so as to levitate the work machine 1A (main body portion 10). In the present embodiment, the air blowing portion 80 includes a blade member 81, a rotary motor 82, a duct 83, an air inlet 84, and an air outlet 85. The blade member 81 is attached to a rotation shaft 82a of the rotary motor 82, and includes, for example, blades extending in the radial direction about the rotation shaft 82a. The rotary motor 82 rotates the rotation shaft 82a to rotate the blade member 81 about the rotation shaft 82a. The duct 83 connects the air inlet 84 and the air outlet 85, and accommodates the blade member 81 therein (between air inlet 84 and air outlet 85). Additionally, by providing the air inlet 84 in the vicinity of the motor 26, the motor 26 as a heat source can be cooled by the air taken into the duct 83 from the air inlet 84.

In the air blowing portion 80, when the rotary motor 82 rotates the blade member 81, outside air is taken into the duct 83 from the air inlet 84. The air taken into the duct 83 is sent to the blade member 81 located downstream of the air inlet 84, and compressed (pressurized) by the rotation of the blade member 81. The air compressed by the blade member 81 is ejected onto the work plane WP from the air outlet 85 located downstream of the blade member 81, and forms the airflow AF from the air outlet 85 toward the work plane WP. The air blowing portion 80 continuously compresses air taken in from the air inlet 84 and injects the air onto the work plane WP below the work machine 1A (main body portion 10) (i.e., continuously forms airflow AF by compressed air), thereby applying a levitating force to the work machine 1A. Accordingly, the work machine 1A can be levitated by the airflow AF generated by the air blowing portion 80.

Additionally, as a mechanism for changing the direction of air injected from the air outlet 85, that is, the direction of air injected by the air blowing portion 80, in the present embodiment, a change mechanism 86 for changing the direction (attitude) of the blade member 81 with respect to the work plane WP is provided in the air blowing portion 80. As indicated by arrows in FIG. 1, the change mechanism 86 has a function of rotating the blade member 81 with at least two axes along the front-and-rear direction (X direction) of the work machine 1A and the width direction (Y direction) of the work machine 1A as rotation axes. The direction of the airflow AF can be changed by changing the direction of the blade member 81 with respect to the work plane WP through the change mechanism 86. It is also possible to apply a propulsive force to the work machine 1A (main body portion 10) by forming the airflow AF in the front-and-rear direction or the left-and-right direction of the work machine 1A, for example. In other words, the air blowing portion 80 can generate the airflow AF so as to move the work machine 1A along the work plane WP in cooperation with the change mechanism 86. In this case, since the air blowing portion 80 also has a function of causing the work machine 1A to travel, as described above, the work machine 1A does not necessarily have to include the traveling portion 20. Additionally, the air blowing portion 80 or the traveling portion 20 may be used supplementarily to cause the work machine 1A to travel. Furthermore, a function of causing the work machine 1A to travel may be achieved by the air blowing portion 80, and it is possible to provide only the front wheels 22 and the rear wheels 24 in the work machine 1A as assistance of such travel.

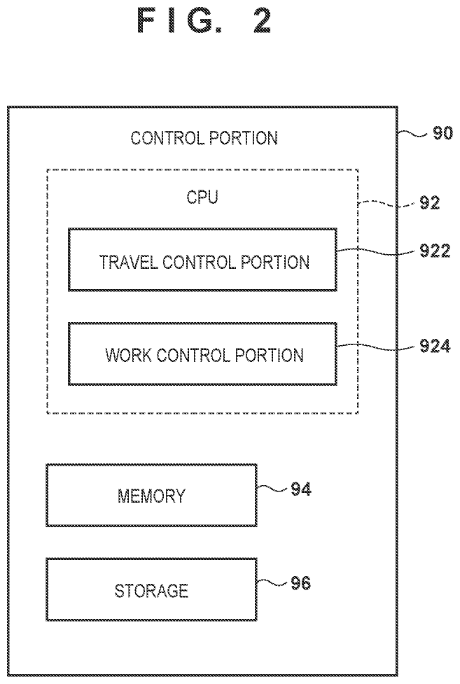

The control portion 90 is an electronic control unit (ECU), and includes a central processing unit (CPU) 92, a memory 94, and a storage 96 as illustrated in FIG. 2. FIG. 2 is a diagram illustrating an example of a configuration of the control portion 90. The CPU 92 controls each portion of the work machine 1A by developing a program stored in the storage 96 in the memory 94 and executing the program. Note that the function of the control portion 90 may be implemented by a semiconductor integrated circuit such as a programmable logic device (PLD) or an application specific integrated circuit (ASIC), or may be implemented by software. In other words, the function of the control portion 90 can be implemented by both hardware and software.

In the present embodiment, the CPU 92 functions as a travel control portion 922 and a work control portion 924. For example, the CPU 92 functions as the travel control portion 922 to control the traveling portion 20 (or air blowing portion 80) on the basis of various types of information detected by the detection portion 30, and functions as the work control portion 924 to control the air blowing portion 80 on the basis of various types of information acquired by the area monitoring portion 40, the setting portion 50, and the environment monitoring portion 60. As a result, a function of performing work of automatically and autonomously traveling in the work area and moving scattered objects without requiring operation by the worker is achieved. Note that in the following description, in order to facilitate the description, the control portion 90 will be described as the control subject.

The control portion 90 integrally controls each portion of the work machine 1A to operate the work machine 1A. In the present embodiment, the control portion 90 controls the air blowing portion 80 on the basis of scattered object information acquired by the area monitoring portion 40 and target information acquired by the setting portion 50. For example, the control portion 90 first specifies a target position, which is a destination to which the scattered objects are to be moved, from target information acquired by the setting portion 50. Next, while controlling the traveling portion 20 to cause the work machine 1A to travel in the work area, the control portion 90 controls the area monitoring portion 40 to acquire scattered object information regarding scattered objects present in the work area. Next, based on the scattered object information acquired by the area monitoring portion 40, the control portion 90 causes the traveling portion 20 to move the work machine 1A to a position where the scattered objects are present in the work area. Then, as illustrated in FIG. 3, the control portion 90 controls the direction and amount of air (compressed air) ejected by the air blowing portion 80 such that the scattered objects are moved to the target position by the airflow AF generated by the air blowing portion 80. FIG. 3 is a diagram schematically illustrating an example of an operation (work) of the work machine 1A. As described above, by controlling the direction and amount of air injected by the air blowing portion 80 from the positional relationship between the position of the scattered objects present in the work area and the target position, the scattered objects can be efficiently moved to the target position. Note that as described above, the direction of air ejected by the air blowing portion 80 can be controlled by the change mechanism 86, and the amount of air injected by the air blowing portion 80 can be controlled by the number of revolutions or the rotation speed (i.e., output of rotary motor 82) of the blade member 81.

Additionally, by matching the moving direction when the work machine 1A is moved to the position where the scattered objects are present in the work area with the direction in which the scattered objects are moved to the target position, it is possible to efficiently perform the work of moving the scattered objects to the target position. This is particularly useful when the air blowing portion 80 is used instead of the traveling portion 20 to move the work machine 1A.

Additionally, it is preferable that the control portion 90 control the air blowing portion 80 such that the larger the amount of scattered objects included in the scattered object information acquired by the area monitoring portion 40, the larger the amount of air injected by the air blowing portion 80 at the position where the scattered objects are present. As a result, it is possible to reduce the amount of scattered objects that could not be moved to the target position by the airflow AF, that is, the residual amount of scattered objects.

Additionally, the control portion 90 may control the traveling portion 20 (motor 26) or the air blowing portion 80 such that the larger the amount of scattered objects included in the scattered object information acquired by the area monitoring portion 40, the slower the moving speed of the work machine 1A (main body portion 10) at the position where the scattered objects are present becomes. As a result, as in the case of increasing the amount of air injected by the air blowing portion 80, it is possible to reduce the amount of scattered objects that could not be moved to the target position by the airflow AF, that is, the residual amount of scattered objects.

It is preferable that the control portion 90 control the direction and amount of air ejected by the air blowing portion 80 so that the scattered objects move to the target position by the airflow AF generated by the air blowing portion 80, based not only on the scattered object information acquired by the area monitoring portion 40 and the target information acquired by the setting portion 50, but also environment information acquired by the environment monitoring portion 60. As a result, it is possible to perform work of moving the scattered objects to the target position according to the environment of the work area.

For example, consider a case where environment information includes information indicating a wind direction in the work area. In this case, the control portion 90 can move scattered objects to the target position more efficiently while reducing (preventing) re-scattering of the scattered objects, by controlling the direction and amount of air ejected by the air blowing portion 80 such that the scattered objects move to the target position along the wind direction included in the environment information acquired by the environment monitoring portion 60.

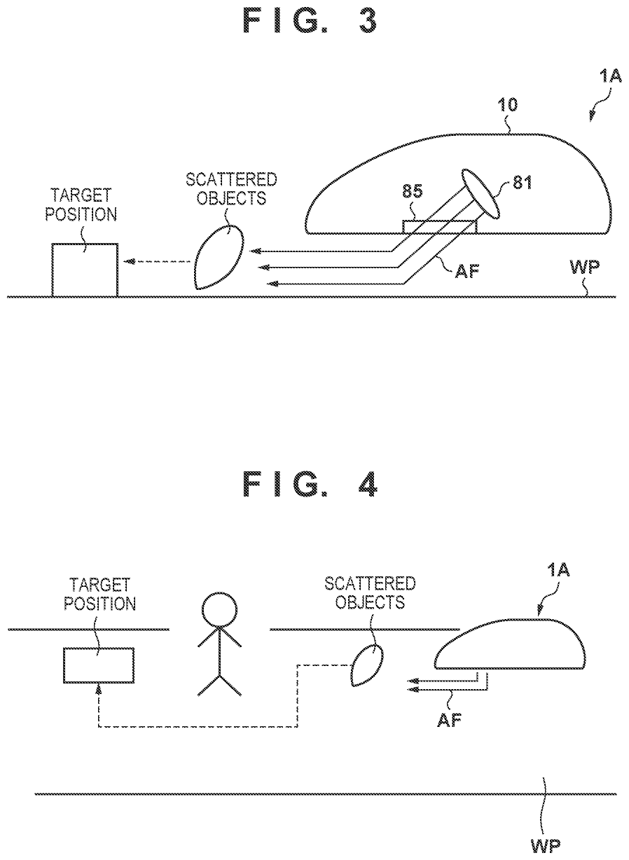

Additionally, a case where environment information includes information indicating a position of a person present in the work area will be considered. In this case, as shown in FIG. 4, the control portion 90 controls the direction and amount of air ejected by the air blowing portion 80 such that the scattered objects move to the target position while avoiding the position of a person included in the environment information acquired by the environment monitoring portion 60. FIG. 4 is a diagram schematically illustrating an example of an operation (work) of the work machine 1A. As described above, by moving the scattered objects in consideration of people present around the work machine 1A, it is possible to keep (prevent) the scattered objects from hitting people.

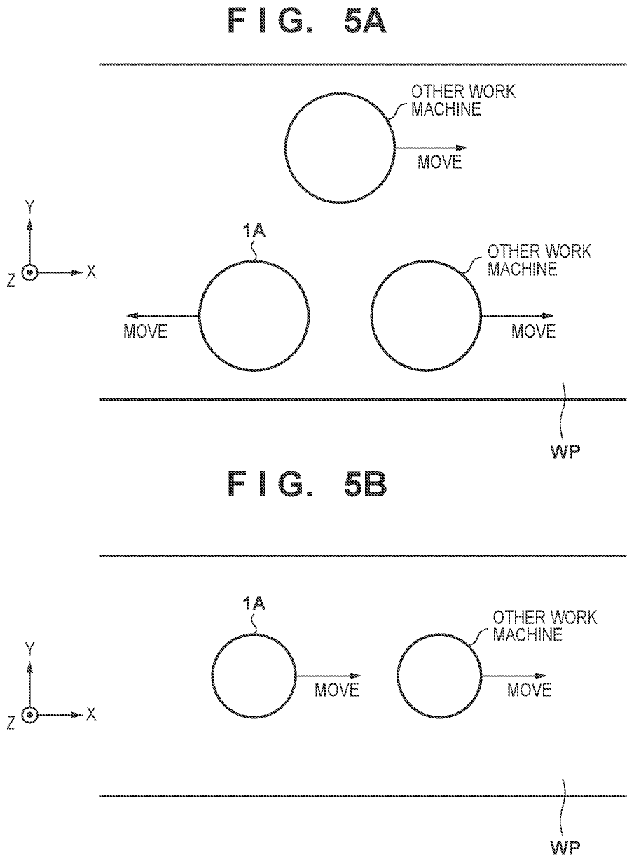

In an actual scene, there may be a case where the work of moving scattered objects to the target position is performed not only by one work machine 1A, but together with a plurality of work machines, that is, other work machines. In such a case, it is preferable that the control portion 90 control the movement of the work machine 1A using information regarding other work machines acquired by the communication portion 70. For example, the control portion 90 moves the work machine 1A (main body portion 10) along the work plane WP such that the work machine 1A does not interfere with other work machines as illustrated in FIG. 5A, on the basis of route information indicating routes along which other work machines move acquired by the communication portion 70. As a result, the work machine 1A can perform the work of moving scattered objects to the target position without disturbing work performed by other work machines, and work efficiency can be improved. Alternatively, based on the route information acquired by the communication portion 70, as illustrated in FIG. 5B, the control portion 90 may move the work machine 1A (main body portion 10) along the work plane WP such that the work machine 1A follows another work machine. As a result, the work machine 1A can perform work in cooperation with other work machines, and work efficiency can be improved. This is particularly useful because when work performed by the other work machine generates scattered objects, such as when the other work machine performs mowing, the mowed turf that is the scattered objects can be immediately moved to the target position. Furthermore, the work machine 1A and a plurality of other work machines may perform work in formation (in an orderly manner). Here, FIGS. 5A and 5B are diagrams schematically illustrating an example of an operation (work) of the work machine 1A.

As described above, according to the present embodiment, it is possible to provide a work machine that efficiently moves scattered objects present in a work area to a target position.

### Second Embodiment

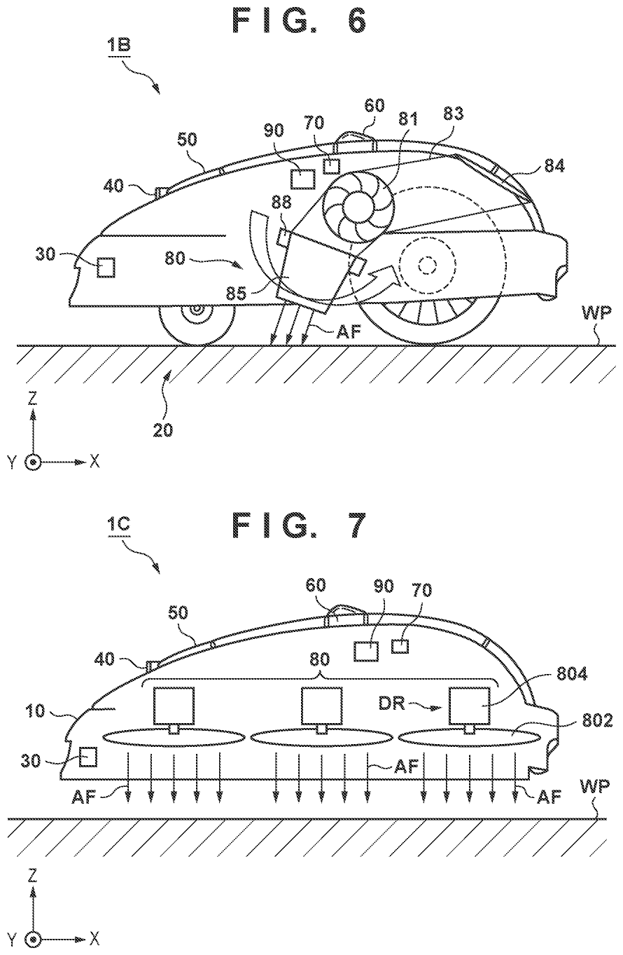

FIG. 6 is a schematic view illustrating a configuration of a work machine 1B according to a second embodiment of the present invention, and is a side view of the work machine 1B. Similarly to the work machine 1A, the work machine 1B is embodied as an autonomous work machine, a so-called blower, that performs work of moving (collecting) scattered objects present in a work area such as a road or a park. The work machine 1B basically has a configuration similar to that of the work machine 1A, but differs from the work machine 1A in a mechanism for changing the direction of air injected from an air outlet 85, that is, the direction of air injected by an air blowing portion 80. Specifically, in the work machine 1B, the change mechanism 86 is replaced with a change mechanism 88.

The change mechanism 88 changes the direction (orientation) of the air outlet 85 with respect to a work plane WP. As indicated by an arrow in FIG. 6, the change mechanism 88 has a function of rotating the air outlet 85 with at least an axis along the width direction (Y direction) of the work machine 1B as a rotation axis. Further, the change mechanism 88 preferably has a function of rotating the air outlet 85 with an axis along the front-and-rear direction (X direction) of the work machine 1B as a rotation axis. The direction of an airflow AF can be changed similarly to the work machine 1 by changing the direction of the air outlet 85 with respect to the work plane WP through the change mechanism 88.

Similarly to the first embodiment, the present embodiment, too, can provide a work machine that efficiently moves scattered objects present in a work area to a target position.

### Third Embodiment

FIG. 7 is a schematic view illustrating a configuration of a work machine 1C according to a third embodiment of the present invention, and is a side view of the work machine 1C. Similarly to the work machine 1A, the work machine 1C is embodied as an autonomous work machine, a so-called blower, that performs work of moving (collecting) scattered objects present in a work area such as a road or a park. The work machine 1C basically has a configuration similar to that of the work machine 1A. Note, however, that the work machine 1C is different from the work machine 1A in that the traveling portion 20 is not provided, and the work unit that actually performs the work of moving the scattered objects present in the work area to the target position is different. Specifically, in the work machine 1C, the air blowing portion 80 is replaced with an air blowing portion 80C.

The air blowing portion 80C is provided in a main body portion 10, and ejects air toward a work plane WP to generate an airflow AF so as to levitate and move the work machine 1C (main body portion 10). The air blowing portion 80C includes a drone (unmanned aerial vehicle) DR, and includes three drones DR in the present embodiment. Note, however, that the number of drones DR configured as the air blowing portion 80C is not limited.

The air blowing portion 80C includes, as the drone DR, a plurality of (e.g., four) rotary blades (propellers) 802 and a motor 804 that rotates each of the plurality of rotary blades 802. In the air blowing portion 80C, when the motor 804 rotates the rotary blade 802, air compressed by the rotary blade 802 is ejected onto a work plane WP from an air outlet 85 located below the rotary blade 802, and forms an airflow AF from the air outlet 85 toward the work plane WP.

In the present embodiment, the control portion 90 controls the rotation direction and the rotation speed of each of the plurality of rotary blades 802. As a result, it is possible to control (change) the levitation and movement of the work machine 1C, that is, the direction of the airflow AF. Accordingly, even when the drone DR is used as the air blowing portion 80C, it is possible to control the direction and amount of air ejected by the air blowing portion 80C such that scattered objects are moved to a target position by the airflow AF generated by the air blowing portion 80C. By controlling the direction and amount of air ejected by the air blowing portion 80 from the positional relationship between the position of the scattered objects present in the work area and the target position, the scattered objects can be efficiently moved to the target position.

As described above, similarly to the first embodiment and the second embodiment, the present embodiment, too, can provide a work machine that efficiently moves scattered objects present in a work area to a target position.

### Summary of Embodiments

1. A work machine of the above-described embodiment is an autonomous work machine (e.g., 1A, 1B, 1C) including:

a main body portion (e.g., 10);

an air blowing portion (e.g., 80, 80C) that is provided in the main body portion and ejects air toward a work plane (e.g., WP) to generate an airflow (e.g., AF);

a first acquisition portion (e.g., 40) that acquires scattered object information regarding scattered objects present in a work area;

a second acquisition portion (e.g., 50) that acquires target information regarding a target position for moving the scattered objects; and

a control portion (e.g., 90) that controls the air blowing portion on the basis of the scattered object information acquired by the first acquisition portion and the target information acquired by the second acquisition portion, in which

the control portion controls a direction and an amount of the air ejected by the air blowing portion so that the scattered objects are moved to the target position by the airflow generated by the air blowing portion.

According to this embodiment, scattered objects can be efficiently moved to the target position.

2. The work machine (e.g., 1A, 1B, 1C) of the above-described embodiment, in which

the scattered object information includes information indicating a position of the scattered objects in the work area and information indicating an amount of the scattered objects at the position, and

the control portion (e.g., 90) controls the air blowing portion (e.g., 80, 80C) such that the larger the amount of the scattered objects included in the scattered object information acquired by the first acquisition portion (e.g., 40), the larger the ejection amount at the position of the scattered objects included in the scattered object information.

According to this embodiment, it is possible to reduce the amount (residual amount) of scattered objects that could not be moved to the target position by the airflow.

3. The work machine (e.g., 1A, 1B, 1C) of the above-described embodiment, in which

the air blowing portion (e.g., 80, 80C) generates the airflow so as to move the main body portion (e.g., 10) along the work plane (e.g., WP).

According to this embodiment, the main body portion can be moved along the work plane.

4. The work machine (e.g., 1A, 1B, 1C) of the above-described embodiment, in which

the scattered object information includes information indicating a position of the scattered objects in the work area and information indicating an amount of the scattered objects at the position, and

the control portion (e.g., 90) controls the air blowing portion (e.g., 80, 80C) such that the larger the amount of the scattered objects included in the scattered object information acquired by the first acquisition portion (e.g., 40), the slower a moving speed of the main body portion (e.g., 10) at the position of the scattered objects included in the scattered object information.

According to this embodiment, it is possible to reduce the amount (residual amount) of scattered objects that could not be moved to the target position by the airflow.

5. The work machine (e.g., 1A, 1B, 1C) of the above-described embodiment, further including:

a wheel (e.g., 22, 24) that is provided in the main body portion (e.g., 10) and rotatably contacts the work plane (e.g., WP); and

a motor (e.g., 26) that rotates the wheel so as to move the main body portion along the work plane.

According to this embodiment, the main body portion can be moved along the work plane.

6. The work machine (e.g., 1A, 1B, 1C) of the above-described embodiment, in which

the control portion (e.g., 90) controls the motor (e.g., 26) such that the larger the amount of the scattered objects included in the scattered object information acquired by the first acquisition portion (e.g., 40), the slower a moving speed of the main body portion (e.g., 10) at the position of the scattered objects included in the scattered object information.

According to this embodiment, it is possible to reduce the amount (residual amount) of scattered objects that could not be moved to the target position by the airflow.

7. The work machine (e.g., 1A, 1B, 1C) of the above-described embodiment, further including

a third acquisition portion (e.g., 60) that acquires environment information regarding an environment of the work area, in which

the control portion (e.g., 90) controls the ejection direction and the ejection amount such that the scattered objects are moved to the target position by the airflow generated by the air blowing portion (e.g., 80, 80C) also based on the environment information acquired by the third acquisition portion.

According to this embodiment, it is possible to perform an operation of moving scattered objects to the target position according to the environment of the work area.

8. The work machine (e.g., 1A, 1B, 1C) of the above-described embodiment, in which

the environment information includes information indicating a wind direction in the work area, and

the control portion (e.g., 90) controls the ejection direction and the ejection amount such that the scattered objects move to the target position along the wind direction included in the environment information acquired by the third acquisition portion (e.g., 60).

According to this embodiment, it is possible to more efficiently move the scattered objects to the target position while curbing re-scattering of the scattered objects.

9. The work machine (e.g., 1A, 1B, 1C) of the above-described embodiment, in which

the environment information includes information indicating a position of a person present in the work area, and

the control portion (e.g., 90) controls the ejection direction and the ejection amount such that the scattered objects move to the target position while avoiding the position of a person included in the environment information acquired by the third acquisition portion (e.g., 60).

According to this embodiment, it is possible to keep scattered objects from hitting people.

10. The work machine (e.g., 1A, 1B, 1C) of the above-described embodiment, further including

a communication portion (e.g., 70) that communicates with another work machine, in which

the communication portion acquires route information indicating a route along which the other work machine moves from the other work machine, and

the control portion (e.g., 90) moves the main body portion (e.g., 10) along the work plane (e.g., WP) so as not to interfere with the other work machine on the basis of the route information acquired by the communication portion.

According to this embodiment, it is possible to perform the work of moving scattered objects to the target position without disturbing work performed by other work machines, and work efficiency can be improved.

11. The work machine (e.g., 1A, 1B, 1C) of the above-described embodiment, in which

the control portion (e.g., 90) moves the main body portion (e.g., 10) along the work plane (e.g., WP) so as to follow the other work machine.

According to this embodiment, work can be performed in cooperation with other work machines, and work efficiency can be improved.

12. The work machine (e.g., 1A, 1B, 1C) of the above-described embodiment, further including

a change mechanism (e.g., 86, 88) that changes the direction of the air ejected by the air blowing portion (e.g., 80, 80C).

According to this embodiment, the direction of airflow generated by the air blowing portion can be changed.

13. The work machine (e.g., 1A, 1B, 1C) of the above-described embodiment, in which

the air blowing portion (e.g., 80C) ejects air so as to levitate the main body portion to generate an airflow.

According to this embodiment, scattered objects can be efficiently moved to the target position using a drone.

The invention is not limited to the foregoing embodiments, and various variations/changes are possible within the spirit of the invention.

What is claimed is:

1. An autonomous work machine comprising:
a main body portion;
an air blowing portion that is provided in the main body portion and ejects air toward a work plane to generate an airflow;
a first acquisition portion that acquires scattered object information regarding scattered objects present in a work area;
a second acquisition portion that acquires target information regarding a target position for moving the scattered objects; and
a control portion that controls the air blowing portion on the basis of the scattered object information acquired by the first acquisition portion and the target information acquired by the second acquisition portion,
wherein the control portion controls a direction and an amount of the air ejected by the air blowing portion so that the scattered objects are moved to the target position by the airflow generated by the air blowing portion.

2. The work machine according to claim 1, wherein
the scattered object information includes information indicating a position of the scattered objects in the work area and information indicating an amount of the scattered objects at the position, and
the control portion controls the air blowing portion such that the larger the amount of the scattered objects included in the scattered object information acquired by the first acquisition portion, the larger the ejection amount at the position of the scattered objects included in the scattered object information.

3. The work machine according to claim 1, wherein the air blowing portion generates the airflow so as to move the main body portion along the work plane.

4. The work machine according to claim 3, wherein
the scattered object information includes information indicating a position of the scattered objects in the work area and information indicating an amount of the scattered objects at the position, and
the control portion controls the air blowing portion such that the larger the amount of the scattered objects included in the scattered object information acquired by the first acquisition portion, the slower a moving speed of the main body portion at the position of the scattered objects included in the scattered object information.

5. The work machine according to claim 1, further comprising:
a wheel that is provided in the main body portion and rotatably contacts the work plane; and
a motor that rotates the wheel so as to move the main body portion along the work plane.

6. The work machine according to claim 5, wherein the control portion controls the motor such that the larger the amount of the scattered objects included in the scattered object information acquired by the first acquisition portion, the slower a moving speed of the main body portion at the position of the scattered objects included in the scattered object information.

7. The work machine according to claim 1, further comprising
a third acquisition portion that acquires environment information regarding an environment of the work area,
wherein the control portion controls the ejection direction and the ejection amount such that the scattered objects are moved to the target position by the airflow generated by the air blowing portion also based on the environment information acquired by the third acquisition portion.

8. The work machine according to claim 7, wherein
the environment information includes information indicating a wind direction in the work area, and
the control portion controls the ejection direction and the ejection amount such that the scattered objects move to the target position along the wind direction included in the environment information acquired by the third acquisition portion.

9. The work machine according to claim 7, wherein
the environment information includes information indicating a position of a person present in the work area, and
the control portion controls the ejection direction and the ejection amount such that the scattered objects move to the target position while avoiding the position of a person included in the environment information acquired by the third acquisition portion.

10. The work machine according to claim 3, further comprising
a communication portion that communicates with another work machine,
wherein the communication portion acquires route information indicating a route along which the other work machine moves from the other work machine, and
the control portion moves the main body portion along the work plane so as not to interfere with the other work machine on the basis of the route information acquired by the communication portion.

11. The work machine according to claim 10, wherein the control portion moves the main body portion along the work plane so as to follow the other work machine.

12. The work machine according to claim 1, further comprising a change mechanism that changes the direction of the air ejected by the air blowing portion.

13. The work machine according to claim 1, wherein the air blowing portion ejects air so as to levitate the main body portion to generate an airflow.
